(19) United States
(12) Patent Application Publication
(10) Pub. No.: US 2020/0029106 A1
(43) Pub. Date: Jan. 23, 2020

(54) OBJECT IDENTIFICATION METHOD AND SYSTEM, AND DEVICE

(71) Applicant: Huawei Technologies Co., Ltd., Shenzhen (CN)

(72) Inventor: Liangliang LIU, Xi'an (CN)

(21) Appl. No.: 16/586,291

(22) Filed: Sep. 27, 2019

Related U.S. Application Data
(63) Continuation of application No. PCT/CN2018/077111, filed on Feb. 24, 2018.

(30) Foreign Application Priority Data
Mar. 29, 2017 (CN) 201710198699.0

(51) Int. Cl. H04N 21/234; H04N 21/2662; G06K 9/32; G09G 3/34

(52) U.S. Cl. CPC H04N 21/23418; H04N 21/2662; G09G 2320/0646; G09G 3/3406; G06K 9/3241

(57) ABSTRACT

An object identification method is provided. The method includes: receiving a video stream from a video obtaining system, where the video stream includes a to-be-identified object; determining a compensation element for the to-be-identified object, where the compensation element is used to represent an element that needs to be adjusted for the to-be-identified object; sending the compensation element and a compensation parameter of the compensation element to the video obtaining system; and receiving an adjusted video stream sent by the video obtaining system, where the adjusted video stream is a video stream after the video obtaining system adjusts the compensation element for the to-be-identified object based on the compensation parameter.

### CROSS-REFERENCE TO RELATED APPLICATIONS

This application is a continuation of International Application No. PCT/CN2018/077111, filed on Feb. 24, 2018, which claims priority to Chinese Patent Application No. 201710198699.0, filed on Mar. 29, 2017. The disclosures of the aforementioned applications are hereby incorporated by reference in their entireties.

### TECHNICAL FIELD

This application relates to the field of communications technologies, and in particular, to an object identification method and system, and a device.

### BACKGROUND

With development of the mobile Internet, various object identification applications are increasingly widely used. A large quantity of technology companies and venture companies invest in related researches, and more related applications appear in the public. For example, a human-centered intelligent visual analysis technology is at a developing stage, and focuses on face detection and face identification.

A smile analysis technology from Face++ (a company) can analyze whether a person in a picture or a video stream is smiling and his/her smiling degree. The smile analysis technology can capture each moment of smiling, implement a “smile shutter” in a camera application, and can further interact with a device by using a smile. Users themselves can set different smiling degrees, and make such a setting that smiling faces of adults or children are captured preferentially, and the like.

There is a gender-identification billboard in London, and the billboard is located at one bus stop on Oxford Street in London. With the help of a high-definition camera, built-in software can judge the gender of a pedestrian based on facial features of the pedestrian, with accuracy up to 90%. In the future, more targeted advertisements are expected to be released based on age, race, and size to apply the technology to newsstands, vending machines, and digital billboards. For example, advertisements are customized for different age groups. When a child passes through, a Lego advertisement is played, and when an adult passes through, the advertisement is changed to a watch advertisement.

However, for an object identification technology including face identification, when an identification condition is unfavorable, information that has been lost in an image cannot be properly restored. As a result, identification accuracy is affected.

### SUMMARY

Embodiments of the present application provide an object identification method and system, and a device, to resolve a prior-art problem that identification accuracy is affected when an identification condition is unfavorable, to improve identification accuracy.

To achieve the foregoing objective, the embodiments of the present application provide the following technical solutions.

According to a first aspect, an embodiment of the present application provides an object identification method. The method includes: first, receiving a video stream from a video obtaining system, where the video stream includes a to-be-identified object; then, determining a compensation element for the to-be-identified object, where the compensation element is used to represent an element that needs to be adjusted for the to-be-identified object; sending the compensation element and a compensation parameter of the compensation element to the video obtaining system after the compensation element is determined; and finally, receiving an adjusted video stream sent by the video obtaining system, where the adjusted video stream is a video stream after the video obtaining system adjusts the compensation element for the to-be-identified object based on the compensation parameter. In the foregoing method, the video obtaining system may adjust a compensation element for an identified object based on a compensation parameter to obtain an adjusted video stream, so that a prior-art problem that identification accuracy is affected when an identification condition is unfavorable is resolved, and object identification accuracy is improved.

In a possible design, the compensation element includes an angle, and the compensation parameter includes a location area of the to-be-identified object and a target angle of the to-be-identified object.

Correspondingly, the determining a compensation element for the to-be-identified object includes: obtaining a current angle of the to-be-identified object in the video stream and the target angle of the to-be-identified object; and if a deviation between the current angle of the to-be-identified object in the video stream and the target angle of the to-be-identified object exceeds a preset threshold, determining that an angle of the to-be-identified object needs to be adjusted. The angle of the to-be-identified object is an important factor that affects identification accuracy. If an angle deviation is excessively large, it is quite difficult to accurately identify the object. The angle of the to-be-identified object is adjusted, so that identification accuracy can be greatly improved.

In a possible design, the compensation element includes resolution, and the compensation parameter includes a location area of the to-be-identified object and target resolution of the to-be-identified object.

Correspondingly, the determining a compensation element for the to-be-identified object includes: obtaining current resolution of the to-be-identified object in the video stream and target resolution of the to-be-identified object; and if the current resolution of the to-be-identified object in the video stream is lower than the target resolution of the to-be-identified object, determining that resolution of the to-be-identified object needs to be adjusted. The resolution of the to-be-identified object is an important factor that affects identification accuracy. If the resolution is excessively low, it is quite difficult to accurately identify the object. The resolution of the to-be-identified object is adjusted, so that identification accuracy can be greatly improved.

In a possible design, the compensation element includes brightness, and the compensation parameter includes a location area of the to-be-identified object and target brightness of the to-be-identified object.

Correspondingly, the determining a compensation element for the to-be-identified object includes: obtaining current brightness of the to-be-identified object in the video stream and the target brightness of the to-be-identified object; and if a deviation between the current brightness of the to-be-identified object in the video stream and the target brightness of the to-be-identified object exceeds a preset threshold, determining that brightness of the to-be-identified object needs to be adjusted. The brightness of the to-be-identified object is an important factor that affects identification accuracy. If the brightness is excessively low, it is quite difficult to accurately identify the object. The brightness of the to-be-identified object is adjusted, so that identification accuracy can be greatly improved.

According to a second aspect, an embodiment of the present application provides an object identification method. The method includes: first, receiving, by a video obtaining system, a compensation element and a compensation parameter that are for a to-be-identified object and that are sent by a video service device, where the compensation element is used to represent a factor that is to be adjusted for the to-be-identified object; and after receiving the compensation parameter and the compensation element, adjusting, by the video obtaining system, the compensation element for the to-be-identified object based on the compensation parameter; and then, sending, by the video obtaining system, an adjusted video stream to the video service device, where the adjusted video stream includes a to-be-identified object obtained after the compensation element is adjusted.

In a possible design, the compensation element includes an angle, and the compensation parameter includes a location area of the to-be-identified object and a target angle of the to-be-identified object.

In actual implementation, the video obtaining system may be one video obtaining device. Correspondingly, the adjusting the compensation element for the to-be-identified object based on the compensation parameter includes: adjusting a location of the video obtaining device based on the target angle, so that an updated angle of the to-be-identified object in the location area meets a requirement of the target angle. An angle of an identified object is adjusted, so that the identified object is clearer and identification accuracy can be greatly improved.

In actual implementation, the video obtaining system may include a control device and at least two video obtaining devices, and the at least two video obtaining devices include a first video obtaining device and a second video obtaining device.

Correspondingly, in a possible design, the adjusting, by the video obtaining system, the compensation element for the to-be-identified object based on the compensation parameter includes: after receiving the compensation element and the compensation parameter that are sent by the video service device, comparing, by the control device, a current angle and the target angle of the to-be-identified object in the location area to determine a direction in which the first video obtaining device needs to move, and controlling the first video obtaining device to move, so that an angle of the to-be-identified object meets a requirement of the target angle.

Correspondingly, in another possible design, the controlling the first video obtaining device to move, so that an angle of the to-be-identified object meets a requirement of the target angle specifically includes: if the requirement of the target angle still cannot be met after the first video obtaining device moves, controlling the second video obtaining device to move, so that the angle of the to-be-identified object meets the requirement of the target angle.

During specific implementation, if the requirement of the target angle still cannot be met after the second video obtaining device moves, a third video obtaining device in a camera group is controlled to move until the angle of the to-be-identified object meets the requirement of the target angle.

In a possible design, the compensation element includes resolution, and the compensation parameter includes a location area of the to-be-identified object and target resolution of the to-be-identified object.

Correspondingly, the adjusting the compensation element for the to-be-identified object based on the compensation parameter includes: improving resolution of the to-be-identified object in the location area, so that obtained resolution of the to-be-identified object meets a requirement of the target resolution. Resolution of an identified object is improved, so that the identified object is clearer and identification accuracy can be greatly improved.

In a possible design, the compensation element includes brightness, and the compensation parameter includes a location area of the to-be-identified object and brightness of the to-be-identified object.

Correspondingly, the adjusting the compensation element for the to-be-identified object based on the compensation parameter includes: enhancing, by the video obtaining system, brightness of the to-be-identified object in the location area, so that obtained brightness of the to-be-identified object meets a requirement of target brightness. Brightness of an identified object is enhanced, so that the identified object is clearer and identification accuracy can be greatly improved.

In a possible design, the enhancing, by the video obtaining system, brightness of the to-be-identified object in the location area includes: adjusting a light compensation function of a video obtaining device or adjusting light sensitivity of a video obtaining device.

According to a third aspect, an embodiment of the present application provides an object identification apparatus, and the apparatus has a function of implementing an execution body of the method embodiment provided in any possible design of the first aspect or any possible design of the second aspect. The function may be implemented by using hardware, or may be implemented by hardware executing corresponding software. The hardware or software includes one or more modules corresponding to the function.

According to a fourth aspect, an embodiment of the present application provides an object identification device, including: a processor, a memory, a bus, and a communications interface. The memory is configured to store a computer-executable instruction. The processor and the memory are connected by using the bus. When the device runs, the processor executes the computer-executable instruction stored in the memory, so that the object identification device performs the object identification method according to any possible design of the first aspect or any possible design of the second aspect.

According to a fifth aspect, an embodiment of the present application provides an object identification system, including an execution body in the foregoing method embodiment or device embodiment.

According to a sixth aspect, an embodiment of the present application provides a computer program product including an instruction. When the computer program product is run on a computer, the computer is enabled to perform the methods in the foregoing aspects.

According to a seventh aspect, an embodiment of the present application provides a computer storage medium, including an instruction. When the instruction is run on a computer, the computer is enabled to perform the methods in the foregoing aspects.

These aspects or other aspects of this application are clearer and more comprehensible in descriptions of the following embodiments.

### BRIEF DESCRIPTION OF DRAWINGS

FIG. 1 is a schematic diagram of a possible system network according to an embodiment of the present application;

FIG. 2 is a schematic diagram of another possible system network according to an embodiment of the present application;

FIG. 3 is a schematic diagram of a computer device according to an embodiment of the present application;

FIG. 4 is a schematic flowchart of an object identification method according to an embodiment of the present application;

FIG. 5 is a schematic flowchart of another object identification method according to an embodiment of the present application;

FIG. 6 is a schematic flowchart of another object identification method according to an embodiment of the present application;

FIG. 7 is a schematic flowchart of another object identification method according to an embodiment of the present application;

FIG. 8 is a schematic flowchart of another object identification method according to an embodiment of the present application;

FIG. 9 is a schematic structural diagram of a video service device according to an embodiment of the present application; and

FIG. 10 is a schematic structural diagram of a video obtaining device according to an embodiment of the present application.

### DESCRIPTION OF EMBODIMENTS

To make the objectives, technical solutions, and advantages of the present application clearer, the following further describes this application in detail with reference to the accompanying drawings. A specific operation method in a method embodiment may also be applied to an apparatus embodiment or a system embodiment.

A network architecture and a service scenario described in the embodiments of the present application are intended to describe the technical solutions in the embodiments of the present application more clearly, and do not constitute a limitation on the technical solutions provided in the embodiments of the present application. Persons of ordinary skill in the art can learn that with evolution of the network architecture and emergence of a new service scenario, the technical solutions provided in the embodiments of the present application are also applicable to similar technical problems.

An embodiment of the present application provides an object identification system 100. The system 100 includes a video obtaining system 10 and a video service device 12.

First, the video service device 12 receives a video stream from the video obtaining system 10, and the video stream includes a to-be-identified object. Then, the video service device 12 determines a compensation element for the to-be-identified object, and the compensation element is used to represent an element that needs to be adjusted for the to-be-identified object. After determining the compensation element, the video service device 12 sends the compensation element and a compensation parameter of the compensation element to the video obtaining system 10. The video obtaining system 10 adjusts the compensation element for the to-be-identified object based on the received compensation parameter, and then sends an adjusted video stream to the video service device 12. The adjusted video stream includes a to-be-identified object obtained after the compensation element is adjusted. The video service device 12 receives the adjusted video stream sent by the video obtaining system 10. The adjusted video stream is a video stream after the video obtaining system 10 adjusts the compensation element for the to-be-identified object based on the compensation parameter.

During specific implementation, the video obtaining system 10 may include one video obtaining device, or may include a plurality of video obtaining devices.

If there are a plurality of video obtaining devices, the video obtaining system 10 may further include one control device, and the control device controls the plurality of video obtaining devices. Specific implementation is described in the following method embodiments.

During specific implementation, the compensation element may be an angle, resolution, or brightness, or may be another element. This is not limited in this application.

After receiving the video stream that is sent by the video obtaining system 10 and that includes the to-be-identified object, the video service device 12 determines the compensation element for the to-be-identified object. The method for determining the compensation element for the to-be-identified object may be any one of the following manners:

Manner 1: A current angle of the to-be-identified object in the video stream and a target angle of the to-be-identified object are obtained, and if a deviation between the current angle of the to-be-identified object in the video stream and the target angle of the to-be-identified object exceeds a preset threshold, it is determined that an angle of the to-be-identified object needs to be adjusted. In other words, it is determined that the compensation element is the angle of the to-be-identified object.

Manner 2: Current resolution of the to-be-identified object in the video stream and target resolution of the to-be-identified object are obtained, and if the current resolution of the to-be-identified object in the video stream is lower than the target resolution of the to-be-identified object, it is determined that resolution of the to-be-identified object needs to be adjusted. In other words, it is determined that the compensation element is the resolution of the to-be-identified object.

Manner 3: Current brightness of the to-be-identified object in the video stream and target brightness of the to-be-identified object are obtained, and if a deviation between the current brightness of the to-be-identified object in the video stream and the target brightness of the to-be-identified object exceeds a preset threshold, it is determined that brightness of the to-be-identified object needs to be adjusted. In other words, it is determined that the compensation element is the brightness of the to-be-identified object.

Corresponding to Manner 1, if the compensation element is an angle, the compensation parameter includes a location area of the to-be-identified object and the target angle of the to-be-identified object.

Corresponding to Manner 2, if the compensation element is resolution, the compensation parameter includes a location area of the to-be-identified object and the target resolution of the to-be-identified object.

Corresponding to Manner 3, if the compensation element is brightness, the compensation parameter includes a location area of the to-be-identified object and the target brightness of the to-be-identified object.

During specific implementation, the video service device 12 may determine a target angle, target resolution, or target brightness based on the to-be-identified object or a to-be-identified task. The target angle may be a specific angle. Alternatively, the target angle may be a specific angle and a percentage, for example, 50° and 20%, that is, an increase of 20% based on 50°, or certainly, the percentage may be −20%, representing a decrease of 20%. In addition to the foregoing presentation forms of the target angle, there may be another form, and this is not limited in this application. Presentation forms of the target resolution and the target brightness are similar to those of the target angle. Details are not described herein again.

During specific implementation, if the compensation parameter is an angle, the video obtaining system 10 adjusts a location of the video obtaining system 10 based on the target angle, so that an updated angle of the to-be-identified object in the location area meets a requirement of the target angle. “Meet” herein may be that the updated angle is equal to the target angle, or may be that the updated angle is close to the target angle.

During specific implementation, if the compensation parameter is resolution, the video obtaining system 10 improves the resolution of the to-be-identified object in the location area based on the target resolution, so that obtained resolution of the to-be-identified object meets a requirement of the target resolution.

During specific implementation, if the compensation parameter is brightness, the video obtaining system 10 enhances the brightness of the to-be-identified object in the location area, so that obtained brightness of the to-be-identified object meets a requirement of the target brightness.

The foregoing “meet” may be that an updated compensation parameter is equal to a target compensation parameter, or may be that an updated compensation parameter is close to a target compensation parameter.

During specific implementation, the system may compensate for one of a compensation angle, resolution, and brightness for an identified object, or may compensate for at least two of a compensation angle, resolution, and brightness for an identified object. This is not limited in this application. When a plurality of compensations are performed for the identified object, the compensations may be performed sequentially, or the compensations may be performed simultaneously. This is not limited herein.

In the object identification method provided by the system, a prior-art problem that identification accuracy is affected when an object identification condition is unfavorable is resolved, and identification accuracy is improved.

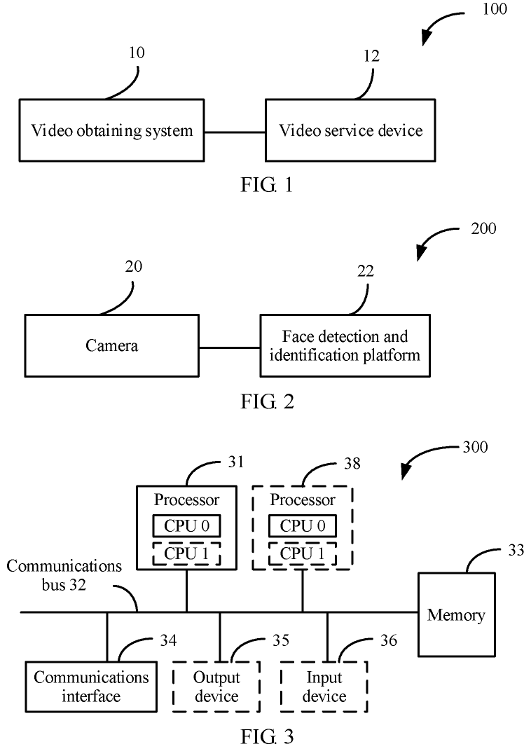

FIG. 2 shows a specific face identification system 200. The system includes a camera 20 and a face detection and identification platform 22. An identified object herein is a face, the camera corresponds to a video obtaining system 10 in FIG. 1, and the face detection and identification platform 22 corresponds to a video service device 12 in FIG. 1.

There may be one camera, or one camera group. If there are a plurality of cameras, that is, the plurality of cameras may photograph the identified object, the system may further include a control device. The control device is configured to control actions of the plurality of cameras, for example, control the cameras to photograph an object or to move.

It should be noted that the video obtaining system 10, the video service device 12, the face detection and identification platform 22, and the like are only names, and the names do not constitute any limitation on the devices. This is not specifically limited in this embodiment of this application. For example, the face detection and identification platform may be a face detection and identification server, a detection platform, or the like. A general description is provided herein, and details are not described in the following again.

It should be noted that in this embodiment of this application, the video obtaining system 10, the video service device 12, and the face detection and identification platform 22 may be implemented by one entity device, or may be jointly implemented by a plurality of entity devices. This is not specifically limited in this embodiment of this application.

As shown in FIG. 3, the video service device 12 or the video obtaining device in FIG. 1, or the camera or the face detection and identification platform in FIG. 2 may be implemented in a manner of a computer device (or a system) in FIG. 3.

FIG. 3 is a schematic diagram of a computer device according to an embodiment of the present application. A computer device 300 includes at least one processor 31, a communications bus 32, a memory 33, and at least one communications interface 34.

The processor 31 may be a general-purpose central processing unit (CPU), a microprocessor, an application-specific integrated circuit (ASIC), or one or more integrated circuits configured to control execution of a program of the solutions of the present application.

The communications bus 32 may include a path used to transmit information between the foregoing components. The communications interface 34 is any apparatus such as a transceiver, and is configured to communicate with another device or a communications network, for example, Ethernet, a radio access network (RAN), or a wireless local area network (WLAN).

The memory 33 may be but is not limited to a read-only memory (ROM) or another type of static storage device that can store static information and an instruction, or a random access memory (RAM) or another type of dynamic storage device that can store information and an instruction; or may be an electrically erasable programmable read-only memory (EEPROM), a compact disc read-only memory (CD-ROM) or another compact disc storage, an optical disc storage (including a compact optical disc, a laser disc, an optical disc, a digital versatile disc, a Blu-ray disc, or the like), a magnetic disk storage medium or another magnetic storage device, or any other medium that can be configured to carry or store expected program code in a form of an instruction or a data structure and that can be accessed by a computer. The memory may exist independently and is connected to the processor by using the bus. The memory may be alternatively integrated with the processor.

The memory 33 is configured to store application code used for executing the solutions of the present application, and the execution is controlled by the processor 31. The processor 31 is configured to execute the application code stored in the memory 33.

During specific implementation, in an embodiment, the processor 31 may include one or more CPUs, for example, a CPU 0 and a CPU 1 in FIG. 3.

During specific implementation, in an embodiment, the computer device 300 may include a plurality of processors such as the processor 31 and a processor 38 in FIG. 3. Each of these processors may be a single-core (single-CPU) processor, or may be a multi-core (multi-CPU) processor. The processor herein may be one or more devices, circuits, and/or processing cores used to process data (for example, a computer program instruction).

During specific implementation, in an embodiment, the computer device 300 may further include an output device 35 and an input device 36. The output device 35 communicates with the processor 31, and may display information in a plurality of manners. For example, the output device 35 may be a liquid crystal display (LCD), a light emitting diode (LED) display device, a cathode ray tube (CRT) display device, or a projector. The input device 36 communicates with the processor 31, and may obtain outside information or receive user input in a plurality of manners. For example, the input device 36 may be a camera, a mouse, a keyboard, a touchscreen device, or a sensing device.

The computer device 300 may be a general-purpose computer device or a dedicated computer device. During specific implementation, the computer device 300 may be a camera device, a desktop computer, a portable computer, a network server, a palmtop computer (Personal Digital Assistant, PDA), a mobile phone, a tablet computer, a wireless terminal device, a communications device, an embedded device, or a device with a structure similar to that in FIG. 3. A type of the computer device 300 is not limited in this embodiment of the present application.

For example, in the video service device 12 or the video obtaining device in FIG. 1, the memory stores one or more software modules. The video service device 12 or the video obtaining device may implement the software module by using the processor and the program code in the memory, to implement object identification.

For example, in the camera or the face detection and identification platform in FIG. 2, the memory stores one or more software modules. The camera or the face detection and identification platform may implement the software module by using the processor and the program code in the memory, to implement object identification.

The following describes, with reference to flowcharts and by using the system shown in FIG. 2 as an example, the object identification methods provided in the embodiments of the present application.

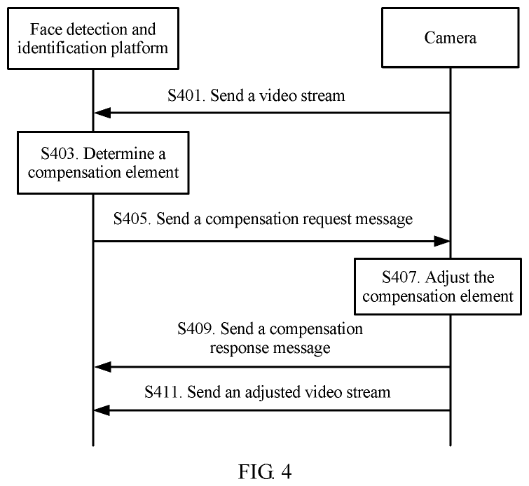

FIG. 4 provides a schematic flowchart of an object identification method. It is assumed herein that a camera is installed at an entrance of a park, and a face detection and identification platform needs to identify persons who enter the park, to find a suspect A required by a public security system.

S401. The camera photographs passersby at a door of the park to generate a video stream including the passersby, the camera sends the video stream to the face detection and identification platform, and the face detection and identification platform receives the video stream.

Herein, a to-be-identified object is a person who enters the park.

S403. The face detection and identification platform performs face detection and identification for the received video stream to determine a compensation element. This embodiment uses an example in which the compensation element is an angle.

Specifically, the face detection and identification platform receives, in real time, the video stream sent by the camera, performs face detection and identification for the video stream, and identifies a person entering the park who is included in the video stream, to find the suspect A required by the public security system.

During specific implementation, information about the suspect A already exists in the face detection and identification platform. The information may be pre-stored in the face detection and identification platform, or may be obtained by the face detection and identification platform from another place in an identification process. It is assumed herein that the information is a face photo of the suspect A. Therefore, an angle of the suspect A may be used as a target angle of the to-be-identified object. For example, if the photo of the suspect A in the face detection and identification platform is a front photo, the target angle herein may be a front angle (in other words, the target angle is 0°); or may be an angle that is close to a front angle (that is, a deviation between the target angle and the front angle is allowed) and that does not affect an identification effect. In this embodiment, for example, the target angle is 10°, and an acceptable threshold is 15°

A method for determining a compensation angle may be: obtaining, by the face detection and identification platform, a current angle of the to-be-identified object in the video stream and the target angle of the to-be-identified object, and if a deviation between the current angle of the to-be-identified object in the video stream and the target angle of the to-be-identified object exceeds a preset threshold, determining that an angle of the to-be-identified object needs to be adjusted, to be specific, determining that the compensation element is an angle. During specific implementation, for a method for determining that an angle needs to be adjusted, refer to solutions in the prior art. Details are not described herein again.

With reference to the foregoing example, the method for determining, by the face detection and identification platform, the compensation angle may be implemented by using the following method. First, the face detection and identification platform analyzes the video stream sent by the camera, and obtains a current angle 30° of a person included in the video stream. Then, the face detection and identification platform compares the current angle with the target angle 10° of the person stored in the face detection and identification platform, and determines that a deviation 20° between the current angle of the to-be-identified object and the target angle of the to-be-identified object exceeds the preset threshold 15°. Therefore, the face detection and identification platform determines that the angle of the to-be-identified object needs to be adjusted.

S405. The face detection and identification platform sends a video compensation request message to the camera, where the video compensation request message includes a compensation angle and a compensation parameter of the angle; and the camera receives the video compensation request message.

Herein, the compensation parameter includes a location area of the to-be-identified object and the target angle 10° of the to-be-identified object. During specific implementation, a rectangular area including a face location is usually used as the location area of the to-be-identified object. Certainly, a circular area or another area including the face location may be used as the location area of the to-be-identified object, and this is not limited in this application. In this embodiment, the rectangular area including the face location is used as the location area of the to-be-identified object.

During specific implementation, the video compensation request message may be a real-time transport control protocol (RTCP) message. The RTCP message may carry parameters shown in the following table. A compensation ID is optional.

| Parameter | | |
|---|---|---|
| names | Parameter descriptions | Examples |
| Compensation | The compensation ID uniquely identifies a | 1001 |
| ID | current compensation request, and no | |
| | repetition is allowed in one session. | |
| Face location | The face location represents a rectangular | (100, 120, |
| | area including the face location, and is | 500, 730) |
| | measured by pixel values in an | |
| | order of left, up, right, and down. | |
| Target angle | The target angle represents is | 10° |
| | measured by a face offset angle | |

S407. After the camera receives the video compensation request message, the camera adjusts a location of the camera based on a target angle in the video compensation request message, so that an updated angle of a to-be-identified object in a location area in the video compensation request message meets a requirement of the target angle.

During specific implementation, after the camera adjusts the location of the camera, a new face angle is calculated in real time until a value of the target angle is met. “Meet” herein may be that an updated face angle is equal to the target angle, or may be that an updated face angle is close to the target angle.

During specific implementation, due to performance limitation of the camera, a case in which an adjusted angle obtained after the camera reaches an adjustment limit still cannot completely meet a requirement of the target angle in the video compensation request message may occur. In this case, a closest angle value that can be reached may be used as the updated face angle.

S409. The camera sends a compensation response message to the face detection and identification platform, and the face detection and identification platform receives the compensation response message, where the compensation response message may carry parameters shown in the following table, and parameter descriptions and examples in the table are further descriptions of the parameters, and may not be carried in the message.

| Parameter | | |
|---|---|---|
| names | Parameter descriptions | Examples |
| Compensation | The compensation ID uniquely identifies a | 1001 |
| ID | current compensation response | |
| | message and is consistent with that in a | |
| | compensation request message. | |
| Compensation | If a target angle can be met, the | 100 |
| angle | compensation angle is the target angle; or | |
| | otherwise, a closest angle is filled in. | |

The compensation ID is optional. If the compensation request message carries the compensation ID, the compensation response message also carries the compensation ID.

During specific implementation, the compensation response message may be an RTCP message.

S411. The camera sends an adjusted video stream to the face detection and identification platform, and correspondingly, the face detection platform receives the adjusted video stream sent by the camera.

The adjusted video stream is a video stream after the camera adjusts the angle of the to-be-identified object based on the compensation angle.

There is no sequence between S411 and S409. The two steps may be performed at the same time or S411 may be performed after or before S409. This is not limited in this application.

According to the object identification method provided in this embodiment, when an angle of an identified object is unfavorable, an angle of the camera may be adjusted to adjust the angle of the identified object, so that identification accuracy is improved.

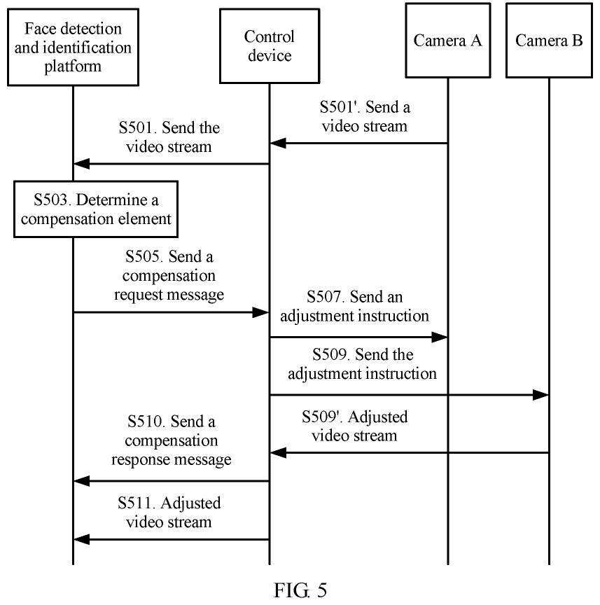

FIG. 5 provides a schematic flowchart of another object identification method. It is assumed herein that a camera group including three cameras A, B, and C is installed at an entrance of a park. The three cameras are controlled by a control device. A face detection and identification platform needs to identify persons who enter the park, to find a suspect A required by a public security system.

The control device may control working statuses of the three cameras. Herein, for example, the control device chooses to enable the camera A to be in a working state, and temporarily turns off the cameras B and C.

S501′. The camera A photographs passersby at a door of the park to generate a video including the passersby, the camera sends the video stream to the control device, and the control device receives the video stream.

S501. The control device sends the video stream to the face detection and identification platform, and the face detection and identification platform receives the video stream.

S503 is the same as S403. Details are not described herein again.

S505 is similar to S405. A difference is that it is the control device that receives a compensation request message. The compensation request message is used to enable the control device to adjust a compensation element based on a video compensation request after the control device receives the video compensation request message.

During specific implementation, the control device may determine, by comparing a current angle and a target angle of the to-be-identified object in a location area, a direction in which the camera A needs to move, and control a first video obtaining device to move, so that an angle of the to-be-identified object meets a requirement of the target angle.

S507. The control device sends an adjustment instruction to the camera A to control the camera A to move, so that an updated angle of a to-be-identified object in a location area in the video compensation request message meets a requirement of a target angle; and the camera A receives the adjustment instruction.

During specific implementation, due to performance limitation of the camera A, a case in which an adjusted angle obtained after the camera A reaches an adjustment limit still cannot completely meet the requirement of the target angle in an angle adjustment request message may occur. Therefore, when determining that the requirement of the target angle still cannot be met after the camera A moves, the control device chooses to enable the camera B to be in the working state.

S509. The control device sends the adjustment instruction to the camera B to control the camera B to move, the camera B receives the adjustment instruction, and after the target angle is met, the control device may send an adjustment stop instruction to the camera B.

Optionally, if the requirement of the target angle still cannot be met after the camera B moves, a location of the camera C is adjusted until a face angle meets a value of the target angle.

It should be noted that S507 to S509 are merely an example of adjusting, by the control device, the compensation element. During specific implementation, the compensation element may also be adjusted by using another method, and this is not limited in this application. For example, in an optional manner, the control device may send an angle adjustment request message to the camera A after determining an angle by which the camera A needs to move. After receiving the angle adjustment request message, the camera A adjusts a location of the camera A to photograph a video stream. However, due to performance limitation of the camera A, an adjusted angle obtained after the camera A reaches an adjustment limit still cannot completely meet the requirement of the target angle in the angle adjustment request message. Then, after receiving a video stream sent by the camera B, the control device sends an angle adjustment request to the camera B, so that the camera B adjusts a location of the camera B. During specific implementation, after the camera B adjusts the location of the camera B, a new face angle is calculated in real time until a value of the target angle is met.

S509′. The camera B sends a newly photographed video stream (namely, an adjusted video stream) to the control device, and the control device receives the adjusted video stream.

S510 is similar to S409. A difference is that it is the control device that sends a compensation response message.

S511. The control device sends the adjusted video stream to the face detection and identification platform, and the face detection and identification platform receives the adjusted video stream.

There is no sequence between S511 and S510. The two steps may be performed at the same time or S511 may be performed after or before S510. This is not limited in this application.

According to the object identification method provided in this embodiment, when an angle of an identified object is unfavorable, an angle of each camera in the camera group may be adjusted to adjust the angle of the identified object, so that identification accuracy is improved.

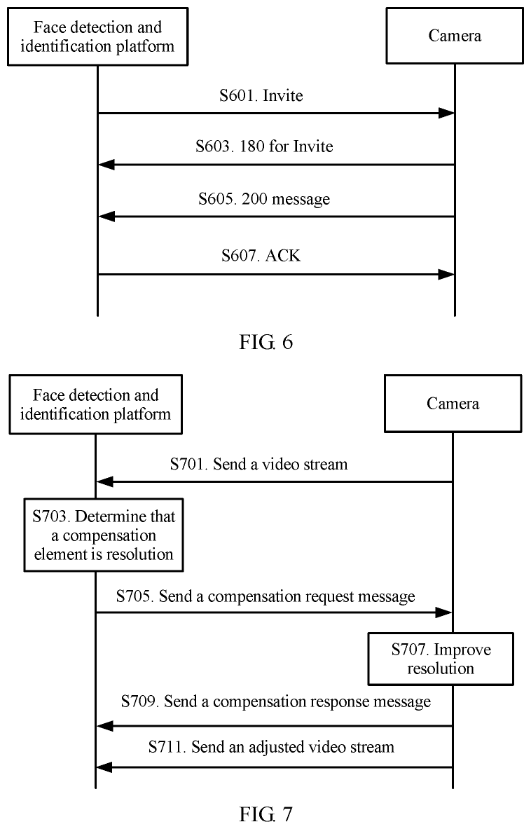

In the methods shown in FIG. 4 and FIG. 5, before S401 or S501′, the face detection and identification platform and the camera, or the face identification platform and the camera group may further negotiate for a compensation element supported by both parties. These negotiation steps are optional. There are a plurality of negotiation methods, and FIG. 6 shows an example.

This embodiment uses an example in which in a session setup phase, the face detection platform and the camera agree through negotiation that both parties support angle compensation. During specific implementation, negotiation may be alternatively conducted in another phase, and this is not limited in this application.

S601. The face detection and identification platform sends a call request invite message to the camera, and the camera receives the call request message, where the invite message carries a session description protocol (SDP) offer (SDP offer).

The SDP offer carries an indicator of a video source compensation-related capability, and represents a video source compensation capability supported by the face detection and identification platform. Related parameters are shown in the following table. Parameter descriptions and examples in the table are further descriptions of the parameters, and may not be carried in the message.

| Parameter | | |
|---|---|---|
| names | Parameter descriptions | Examples |
| Resolution_flag | The resolution_flag represents | |
| | whether resolution compensation | False |
| | is supported. | |
| Brightness_flag | The brightness_flag represents | |
| | whether brightness compensation | False |
| | is supported. | |
| Pose_flag | The pose_flag represents whether | True |
| | angle compensation is supported. | |

S603. After receiving the invite message, the camera determines, based on a capability of the camera, whether to receive an angle compensation capability of the face detection and identification platform, and if the camera agrees to receive the angle compensation capability, the camera adds an SDP answer to a response message 180 for the invite message, where a parameter carried in the message may be the same as that in S601.

S605. The camera sends a response message 200 message to the face detection and identification platform.

S607. The face detection and identification platform sends an ACK message (in other words, an acknowledgment message) to the camera.

According to the foregoing steps, the face detection and identification platform and the camera have completed negotiation for angle compensation. Subsequently, the face detection and identification platform and the camera may perform angle compensation for an identified object.

During specific implementation, the face detection and identification platform and the camera may alternatively negotiate for capabilities of both parties by using an ONVIF protocol. For example, the face detection and identification platform sends a GetDisplayOptionRequest request message to the camera, to obtain a compensation capability of the camera. Correspondingly, the camera sends a GetDisplayOptionRequest response message to the face detection and identification platform, to feed back a compensation capability status supported by the camera.

FIG. 7 provides a schematic flowchart of another object identification method. A scenario is similar to that in FIG. 4. Herein, that a compensation element is resolution is used as an example.

S701 is the same as S401.

S703 is similar to S403. A difference is that the compensation element herein is resolution. In the face detection and identification platform, a public security system may preset, based on empirical values, target resolution to 64×36 and a similarity threshold to 80%. Certainly, the target resolution and the similarity each may be another value, and this is not limited in this application. Similarity is a degree of similarity between a detected identified object (which is a face in this embodiment) and an identified object stored in a video service device (which is the face detection and identification platform in this embodiment).

A method for determining, by the face detection and identification platform, compensation resolution may be as follows: The face detection and identification platform obtains current resolution 32×16 of a face in a video stream. The current resolution of the face in the video stream is lower than the target resolution of the face. Then, the face detection and identification platform determines that resolution of a to-be-identified object needs to be adjusted.

During specific implementation, the face detection and identification platform may obtain the current resolution by using pixel values of an upper left corner and a lower right corner of a location of the identified face. Certainly, the current resolution may be obtained by using another method in the prior art, and this is not limited in this application.

S705 is similar to S405. A difference is that the video compensation request message includes compensation resolution and a compensation parameter. Herein, the compensation parameter is a location area of a to-be-identified object and target resolution of the to-be-identified object. The target resolution is indicated by a pixel value.

S707. The camera improves, by using a scalable video coding (SVC) technology, resolution that is of a face location area and that is indicated in the request message. Certainly, resolution of a larger area including the face location area may be further improved.

A degree of improvement depends on the target resolution in the compensation request message in S705. If the target resolution in the compensation request message cannot be completely reached due to capability limitation of a camera, maximum resolution that the camera can reach is indicated. If the camera can reach the target resolution in the compensation request message, the compensation resolution is the target resolution.

S709 is similar to S409. A difference is that the compensation response message may carry parameters shown in the following table. Parameter descriptions and examples in the table are further descriptions of the parameters, and may not be carried in the message. A compensation ID is optional. If the video compensation request message in S705 carries a compensation ID 1002, the compensation response message in S709 also carries 1002.

| Parameter | | |
|---|---|---|
| names | Parameter descriptions | Examples |
| Compensation | The compensation ID uniquely | 1002 |
| ID | identifies a current compensation | |
| | response message and is consistent | |
| | with that in a request message. | |
| Compensation | If target resolution can be met, the | (64, 36) |
| resolution | compensation resolution is the target | |
| | resolution; or otherwise, | |
| | maximum resolution is filled in. | |

S711 is the same as S411. There is no sequence between S711 and S709.

According to the object identification method provided in this embodiment, when resolution of an identified object is low, the resolution of the identified object may be improved to adjust the resolution of the identified object, so that identification accuracy is improved.

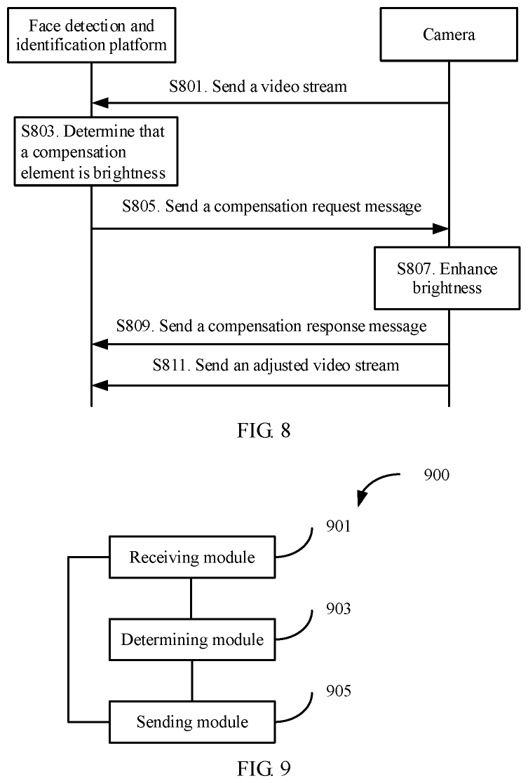

FIG. 8 provides a schematic flowchart of another object identification method. A scenario is similar to that in FIG. 4. Herein, that a compensation element is brightness is used as an example.

S801 is the same as S401.

S803 is similar to S403. A difference is that the compensation element herein is the brightness. In the face detection and identification platform, a public security system may preset, based on empirical values, target brightness to 90 and an acceptable threshold to 30. During specific implementation, the target brightness may be represented by a grayscale value, or may be represented by another parameter provided that brightness of an identified object can be reflected. This is not limited in this application.

A method for determining, by the face detection and identification platform, compensation brightness may be as follows: The face detection and identification platform obtains current brightness 50 of a face in a video stream. A deviation between the current brightness of the face in the video stream and the target brightness of the face is 40, and exceeds the preset threshold 30. Then, the face detection and identification platform determines that brightness of a to-be-identified object needs to be adjusted.

During specific implementation, the current brightness of the face in the video stream may be determined by using an average pixel value of a grayscale image of an image in a face location area, or certainly, the current brightness may be obtained by using another method in the prior art. This is not limited in this application.

S805 is similar to S405. A difference is that the video compensation request message includes compensation brightness and a compensation parameter. Herein, the compensation parameter is a location area of a to-be-identified object and target brightness of the to-be-identified object.

During specific implementation, the video compensation request message may be an RTCP message. The RTCP message may carry parameters shown in the following table. Parameter descriptions and examples in the table are further descriptions of the parameters, and may not be carried in the message. A compensation ID is optional.

| Parameter | | |
|---|---|---|
| names | Parameter descriptions | Examples |
| Compensation | The compensation ID uniquely identifies | 1003 |
| ID | a current compensation request, and no | |
| | repetition is allowed in one session. | |
| Face location | The face location represents a | (100, 120, |
| | rectangular area including the face | 500, 730) |
| | location, and is measured by pixel values | |
| | in an order of left, up, right, and down. | |
| Target | An average pixel value of a grayscale | |
| brightness | image is used as an example of the target | 90 |
| | brightness, that is, the target brightness is | |
| | an integer that does not exceed 255. | |

S807. The camera adjusts brightness of the camera based on the target brightness and a brightness value of a face location area, and calculates the brightness in real time until the target brightness is met, and if the target brightness in the request message cannot be completely reached due to capability limitation of the camera, a closest value that the camera can reach is indicated.

The brightness of the camera may be adjusted in a plurality of manners. For example,

Manner 1: A light compensation function of the camera is adjusted. Specifically, compensation may be performed for photographed content by using a fill light device built in the camera. A fill light lamp needs to have a multi-level light compensation capability to meet different scenarios.

Manner 2: Light sensitivity of the camera is adjusted. Specifically, the light sensitivity of a photosensitive device in the camera may be modified to achieve an objective of adjusting image brightness. Higher ISO light sensitivity indicates higher image brightness under a same condition.

S809 is similar to S409. A difference is that the compensation response message may carry parameters shown in the following table. Parameter descriptions and examples in the table are further descriptions of the parameters, and may not be carried in the message. A compensation ID is optional. If the video compensation request message in S805 carries a compensation ID 1002, the compensation response message in S809 also carries 1002.

| Parameter | | |
|---|---|---|
| names | Parameter descriptions | Examples |
| Compensation | The compensation ID uniquely identifies | 1003 |
| ID | a current compensation request and is | |
| | consistent with that in a request message. | |
| Compensation | If target brightness can be met, the | 90 |
| brightness | compensation brightness is the target | |
| | brightness; or otherwise, | |
| | closest brightness is filled in. | |

S811 is the same as S411. There is no sequence between S811 and S809.

According to the object identification method provided in this embodiment, when brightness of an identified object is insufficient, the brightness of the identified object may be enhanced to adjust the brightness of the identified object, so that identification accuracy is improved.

In the embodiments shown in FIG. 4 to FIG. 8, actions of the face detection and identification platform or the camera may be executed by the face detection platform or the camera by using the foregoing software modules in the memory. This is not limited in the embodiments of the present application.

During specific implementation, in the embodiments shown in FIG. 4 to FIG. 8, the face detection and identification platform may further restore an original video stream after a current identification task ends. If the original video stream needs to be restored, a reset message is sent to the camera. Then, the camera restores the video stream obtained before compensation, and sends a response message to the face detection and identification platform. The reset message may carry a corresponding compensation ID in the foregoing video compensation request message.

The foregoing mainly describes, from a perspective of interaction between network elements, the solutions provided in the embodiments of the present application. It may be understood that to implement the foregoing functions, the foregoing video service device or video obtaining device (or apparatus) includes a corresponding hardware structure and/or software module executing each function. Persons skilled in the art should easily be aware with reference to examples of units and algorithm steps described in the embodiments disclosed in this specification, the present application may be implemented by hardware or a combination of hardware and computer software. Whether a function is executed by hardware or hardware driven by computer software depends on particular applications and design constraints of the technical solutions. Persons skilled in the art may use different methods to implement the described functions for each particular application, but it should not be considered that the implementation goes beyond the scope of the present application.

In the embodiments of the present application, function modules may be divided for the video service device or the video obtaining device based on the foregoing method example. For example, the function modules may be divided according to functions, or two or more functions may be integrated into one processing module. The integrated module may be implemented in a form of hardware, or may be implemented in a form of a software function module. It should be noted that in the embodiments of the present application, module division is an example, and is merely a logical function division. In actual implementation, another division manner may be used.

For example, when the function modules are divided according to the functions, FIG. 9 is a possible schematic structural diagram of a video service device used in the foregoing embodiments. A device 900 includes a receiving module 901, a determining module 903, and a sending module 905.

The receiving module 901 is configured to receive a video stream from a video obtaining system, where the video stream includes a to-be-identified object. The determining module 903 is configured to determine a compensation element for the to-be-identified object, where the compensation element is used to represent an element that needs to be adjusted for the to-be-identified object. The sending module 905 is configured to send the compensation element and a compensation parameter of the compensation element to the video obtaining system. The receiving module 901 is further configured to receive an adjusted video stream sent by the video obtaining system, where the adjusted video stream is a video stream after the video obtaining system adjusts the compensation element for the to-be-identified object based on the compensation parameter.

As described above, the video service device may be a face detection and identification platform, or may be another device that processes a video. This is not specifically limited in this embodiment of this application.

The compensation element may be an angle, resolution, or brightness, or may be another element. This is not specifically limited in this embodiment of this application.

During specific implementation, if the compensation element is an angle, the compensation parameter includes a location area of the to-be-identified object and a target angle of the to-be-identified object. Correspondingly, the determining module 903 is specifically configured to: obtain a current angle of the to-be-identified object in the video stream and the target angle of the to-be-identified object, and if a deviation between the current angle of the to-be-identified object in the video stream and the target angle of the to-be-identified object exceeds a preset threshold, determine that an angle of the to-be-identified object needs to be adjusted.

During specific implementation, if the compensation element is resolution, the compensation parameter includes a location area of the to-be-identified object and target resolution of the to-be-identified object. Correspondingly, the determining module 903 is specifically configured to: obtain current resolution of the to-be-identified object in the video stream and the target resolution of the to-be-identified object, and if the current resolution of the to-be-identified object in the video stream is lower than the target resolution of the to-be-identified object, determine that resolution of the to-be-identified object needs to be adjusted.

During specific implementation, if the compensation element comprises brightness, the compensation parameter includes a location area of the to-be-identified object and target brightness of the to-be-identified object. Correspondingly, the determining module 903 is specifically configured to: obtain current brightness of the to-be-identified object in the video stream and the target brightness of the to-be-identified object, and if a deviation between the current brightness of the to-be-identified object in the video stream and the target brightness of the to-be-identified object exceeds a preset threshold, determine that brightness of the to-be-identified object needs to be adjusted.

All content related to the steps in the foregoing method embodiments may be cited in function description of corresponding function modules. Details are not described herein again.

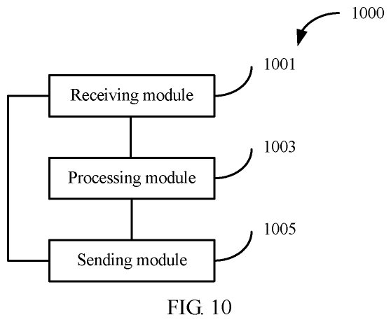

FIG. 10 is a possible schematic structural diagram of a video obtaining device used in the foregoing embodiments. A device 1000 includes a receiving module 1001, a processing module 1003, and a sending module 1005.

The receiving module 1001 is configured to receive a compensation element and a compensation parameter that are for a to-be-identified object and that are sent by a video service device, where the compensation element is used to represent a factor that is to be adjusted for the to-be-identified object. The processing module 1003 is configured to adjust the compensation element for the to-be-identified object based on the compensation parameter. The sending module 1005 is configured to send an adjusted video stream to the video service device, where the adjusted video stream includes a to-be-identified object obtained after the compensation element is adjusted.

As described above, the video obtaining device may be a camera, or may be another device that can obtain a video. This is not specifically limited in this embodiment of this application.

During specific implementation, if the compensation element is an angle, the compensation parameter includes a location area of the to-be-identified object and a target angle of the to-be-identified object. Correspondingly, the processing module 1003 is specifically configured to adjust a location of the video obtaining device based on the target angle, so that an updated angle of the to-be-identified object in the location area meets a requirement of the target angle.

During specific implementation, if the compensation element is resolution, the compensation parameter includes a location area of the to-be-identified object and target resolution of the to-be-identified object. Correspondingly, the processing module 1003 is specifically configured to improve resolution of the to-be-identified object in the location area, so that obtained resolution of the to-be-identified object meets a requirement of the target resolution.

During specific implementation, if the compensation element is brightness, the compensation parameter includes a location area of the to-be-identified object and target brightness of the to-be-identified object. Correspondingly, the processing module 1003 is specifically configured to enhance brightness of the to-be-identified object in the location area, so that obtained brightness of the to-be-identified object meets a requirement of the target brightness.

All content related to the steps in the foregoing method embodiments may be cited in function description of corresponding function modules. Details are not described herein again.

In this embodiment, the video service device or the video obtaining device is presented in a form of dividing each functional module according to a corresponding function, or the video service device or the video obtaining device is presented in a form of dividing each functional module in an integrated manner. The “module” herein may be an application-specific integrated circuit (ASIC), a processor that executes one or more software or firmware programs and a memory, an integrated logic circuit, and/or another component that can provide the foregoing functions. In a simple embodiment, persons skilled in the art may figure out that the video service device 900 and the video obtaining device 1000 may use the form shown in FIG. 3. For example, the receiving module 901, the determining module 903, and the sending module 905 in FIG. 9 may be implemented by using the processor 31 (and/or the processor 38) and the memory 33 in FIG. 3. Specifically, the receiving module 901, the determining module 903, and the sending module 905 may be implemented by the processor 31 (and/or the processor 38) by invoking application code stored in the memory 33. This is not limited in this embodiment of the present application. The receiving module 1001, the processing module 1003, and the sending module 1005 in FIG. 10 may be implemented by using the processor 31 (and/or the processor 38) and the memory 33 in FIG. 3. Specifically, the receiving module 1001, the processing module 1003, and the sending module 1005 may be implemented by the processor 31 (and/or the processor 38) by invoking application code stored in the memory 33. This is not limited in this embodiment of the present application.

An embodiment of the present application further provides a computer storage medium, configured to store a computer software instruction used by the video service device shown in FIG. 9 or the video obtaining device shown in FIG. 10. The computer software instruction includes a program designed for executing the foregoing method embodiments.

An embodiment of the present application further provides a computer program product, configured to store a computer software instruction used by a video service device or a video obtaining device. The computer software instruction includes a program designed for executing the foregoing method embodiments.

In the specification, claims, and accompanying drawings of the embodiments of this application, the terms “first”, “second”, “third”, and the like do not indicate a specific order or sequence. It should be understood that the data termed in such a way is interchangeable in proper circumstances so that the embodiments described herein can be implemented in other orders than the order illustrated or described herein. Moreover, the terms “include”, “have”, and any other variants mean to cover the non-exclusive inclusion, for example, a process, method, system, product, or device that includes a list of steps or units is not necessarily limited to those expressly listed steps or units, but may include other steps or units that are not expressly listed or that are inherent to such a process, method, product, or device.

Although this application is described with reference to the embodiments, in a process of implementing this application that claims protection, persons skilled in the art may understand and implement another variation of the disclosed embodiments by viewing the accompanying drawings, disclosed content, and the appended claims. In the claims, “comprising” does not exclude another component or another step, and “a” or “one” does not exclude a case of multiple. A single processor or another unit may implement several functions enumerated in the claims. Some measures are recorded in dependent claims that are different from each other, but this does not mean that these measures cannot be combined to produce a good effect.

All or some of the foregoing embodiments may be implemented by using software, hardware, firmware, or any combination thereof. When software is used to implement the embodiments, the embodiments may be implemented all or partially in a form of a computer program product. The computer program product includes one or more computer instructions. When the computer program instruction is loaded and executed on a computer, the procedure or functions according to the embodiments of the present application are all or partially generated. The computer may be a general-purpose computer, a dedicated computer, a computer network, or other programmable apparatuses. The computer instruction may be stored in a computer-readable storage medium or may be transmitted from a computer-readable storage medium to another computer-readable storage medium. For example, the computer instruction may be transmitted from a website, computer, server, or data center to another website, computer, server, or data center in a wired (for example, a coaxial cable, an optical fiber, or a digital subscriber line (DSL)) or wireless (for example, infrared, radio, and microwave) manner. The computer-readable storage medium may be any usable medium accessible by a computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid state disk (SSD)), or the like.

In conclusion, the foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of this application.

What is claimed is:

1. An object identification method, comprising:
receiving a first video stream from a video obtaining system, wherein the first video stream comprises a to-be-identified object;
determining a compensation element for the to-be-identified object, wherein the compensation element represents an element to be adjusted for the to-be-identified object;
sending the compensation element and a compensation parameter of the compensation element to the video obtaining system; and
receiving an adjusted video stream, sent by the video obtaining system, wherein the adjusted video stream is a second video stream obtained after the video obtaining system adjusts the compensation element for the to-be-identified object based on the compensation parameter.

2. The method according to claim 1, wherein the compensation element comprises an angle, and the compensation parameter comprises a location area of the to-be-identified object and a target angle of the to-be-identified object.

3. The method according to claim 2, wherein the determining a compensation element for the to-be-identified object comprises:
obtaining a current angle of the to-be-identified object in the video stream and the target angle of the to-be-identified object; and
when a deviation between the current angle of the to-be-identified object in the video stream and the target angle of the to-be-identified object exceeds a preset threshold, determining that an angle of the to-be-identified object needs to be adjusted.

4. The method according to claim 1, wherein the compensation element comprises resolution, and the compensation parameter comprises a location area of the to-be-identified object and a target resolution of the to-be-identified object.

5. The method according to claim 4, wherein the determining a compensation element for the to-be-identified object comprises:
obtaining a current resolution of the to-be-identified object in the video stream and the target resolution of the to-be-identified object; and
when the current resolution of the to-be-identified object in the video stream is lower than the target resolution of the to-be-identified object, determining that a resolution of the to-be-identified object needs to be adjusted.

6. The method according to claim 1, wherein the compensation element comprises brightness, and the compensation parameter comprises a location area of the to-be-identified object and a target brightness of the to-be-identified object.

7. The method according to claim 6, wherein the determining a compensation element for the to-be-identified object comprises:
obtaining a current brightness of the to-be-identified object in the video stream and the target brightness of the to-be-identified object; and
when a deviation between the current brightness of the to-be-identified object in the video stream and the target brightness of the to-be-identified object exceeds a preset threshold, determining that a brightness of the to-be-identified object needs to be adjusted.

8. An object identification method, comprising:
receiving, by a video obtaining system, a compensation element and a compensation parameter that are for a to-be-identified object and that are sent by a video service device, wherein the compensation element represents a factor to be adjusted for the to-be-identified object;
adjusting, by the video obtaining system, the compensation element for the to-be-identified object based on the compensation parameter; and
sending, by the video obtaining system, an adjusted video stream to the video service device, wherein the adjusted video stream comprises a to-be-identified object after the compensation element is adjusted.

9. The method according to claim 8, wherein the compensation element comprises an angle, and the compensation parameter comprises a location area of the to-be-identified object and a target angle of the to-be-identified object.

10. The method according to claim 9, wherein the video obtaining system comprises a video obtaining device; and
the adjusting, by the video obtaining system, the compensation element for the to-be-identified object based on the compensation parameter comprises:
adjusting, by the video obtaining device, a location of the video obtaining device based on the target angle, so that an updated angle of the to-be-identified object in the location area meets a requirement of the target angle.

11. The method according to claim 9, wherein the video obtaining system comprises a control device and at least two video obtaining devices, wherein the at least two video obtaining devices comprise a first video obtaining device and a second video obtaining device; and
the adjusting, by the video obtaining system, the compensation element for the to-be-identified object based on the compensation parameter comprises:
after receiving the compensation element and the compensation parameter that are sent by the video service device, comparing, by the control device, a current angle and the target angle of the to-be-identified object in the location area to determine a direction in which the first video obtaining device needs to move; and
controlling the first video obtaining device to move, so that an angle of the to-be-identified object meets a requirement of the target angle.

12. The method according to claim 11, wherein the controlling the first video obtaining device to move, so that an angle of the to-be-identified object meets a requirement of the target angle specifically comprises:
when it is determined that the requirement of the target angle cannot be met by the first video obtaining device, controlling the second video obtaining device to move, so that the angle of the to-be-identified object meets the requirement of the target angle.

13. The method according to claim 8, wherein the compensation element comprises a resolution, and the compensation parameter comprises a location area of the to-be-identified object and a target resolution of the to-be-identified object.

14. The method according to claim 13, wherein the adjusting, by the video obtaining system, the compensation element for the to-be-identified object based on the compensation parameter comprises:
improving, by the video obtaining system, a resolution of the to-be-identified object in the location area so that obtained resolution of the to-be-identified object meets a requirement of the target resolution.

15. The method according to claim 8, wherein the compensation element comprises a brightness, and the compensation parameter comprises a location area of the to-be-identified object and a target brightness of the to-be-identified object.

16. The method according to claim 15, wherein the adjusting, by the video obtaining system, the compensation element for the to-be-identified object based on the compensation parameter comprises:
enhancing, by the video obtaining system, a brightness of the to-be-identified object in the location area, so that an obtained brightness of the to-be-identified object meets a requirement of the target brightness.

17. The method according to claim 16, wherein the enhancing, by the video obtaining system, the brightness of the to-be-identified object in the location area comprises:
adjusting a light compensation function of a video obtaining device or adjusting light sensitivity of a video obtaining device.

18. A video service device, comprising:
a processor, and a non-transitory memory coupled to the processor for storing computer-executable instructions that, when executed by the processor, cause the video service device to perform the following steps:
receiving a first video stream from a video obtaining system, wherein the first video stream comprises a to-be-identified object;
determining a compensation element for the to-be-identified object, wherein the compensation element represents an element that needs to be adjusted for the to-be-identified object;
sending the compensation element and a compensation parameter of the compensation element to the video obtaining system; and
receiving an adjusted video stream sent by the video obtaining system, wherein the adjusted video stream is a second video stream obtained after the video obtaining system adjusts the compensation element for the to-be-identified object based on the compensation parameter.

19. The video service device according to claim 18, wherein the compensation element comprises an angle, and the compensation parameter comprises a location area of the to-be-identified object and a target angle of the to-be-identified object.

20. The video service device according to claim 19, wherein the determining a compensation element for the to-be-identified object comprises:
obtaining a current angle of the to-be-identified object in the video stream and the target angle of the to-be-identified object; and
when a deviation between the current angle of the to-be-identified object in the video stream and the target angle of the to-be-identified object exceeds a preset threshold, determining that an angle of the to-be-identified object needs to be adjusted.
